(19) United States
(12) Patent Application Publication
(10) Pub. No.: US 2002/0156871 A1
(43) Pub. Date: Oct. 24, 2002

(54) Messaging protocol

(76) Inventors: Andrew Amadeo Munarriz, London (GB); Marco Santulli, London (GB)

Correspondence Address: Christopher J. Rourk, Akin, Gump, Strauss, Hauer & Feld, LLP, Suite 4100, 1700 Pacific Avenue, Dallas, TX, 75201-4675, US

(21) Appl. No.: 10/025,337

(22) Filed: Dec. 19, 2001

(30) Foreign Application Priority Data
Dec. 19, 2000 (GB) 0030944.3

(51) Int. Cl. G06F 15/16

(52) U.S. Cl. 709/219; 709/236

(57) ABSTRACT

A messaging system transfers messages between server and client in XML format. The transfer of messages is by HTTP. The server and client store messages in the XML format. The server can collect messages from various sources, convert those into the XML format and supply them to the client. The XML message may include an instruction to the client or server as to how the message is to be processed, for example sent, stored or deleted. The XML messages can be converted to WML format for display on devices such as mobile phones.

### CROSS REFERENCE TO RELATED APPLICATIONS

This application claims priority to United Kingdom Application No. 0030944.3, entitled “MESSAGING PROTOCOL,” filed Dec. 19, 2000.

### BACKGROUND OF THE INVENTION

Messaging systems are used to deliver messages between computers and other devices over communication networks, such as LAN's, the Internet and mobile phone networks. Email is, of course, one common messaging application but others such as electronic commerce and workflow applications can of course make use of messaging.

There are many existing protocols for transferring messages. Often messaging systems have a client-server configuration with servers transporting the messages and client programs contacting their local servers to initiate and receive the messages. Common protocols used in email are POP3 and IMAP4 for the retrieval of messages from servers and SMTP and X.400 for the transfer of messages between servers.

One server messaging program is Microsoft Exchange and a client program that is commonly used with it is Microsoft Outlook. Messages generated by the client in one format are converted by Exchange into one suitable for communication to the destination server.

Messages to and from mobile phones sometimes make use of a protocol called WML or “Wireless mark-up language”. In this protocol data is sent for display on the mobile phone, the layout of which is defined by tags in the file transferred which are interspersed among the characters that are to be displayed. The transfer of the WML files is coordinated between the client and server using WAP (“Wireless Access Protocol”) and WSP (“Wireless Session Protocol”). WML contains only layout information i.e. it details only how the display of the mobile phone should appear, which display will include, in the example of an email message, of the name of the sender and the text of the message.

### SUMMARY OF THE INVENTION

The present invention provides a new protocol for the format of a message which has advantages over the known protocols.

According to the present invention there is provided a message signal, containing a message, or a machine readable stored message, wherein the message is in a format having delimiters that both: mark regions containing values of fields, and identify which fields those are.

The said format may be XML.

The message signal or the stored message may comprise a field, in said format, indicating the recipient of the message, and/or a field, in said format, indicating the send of the message, and/or a field, in said format, indicating the address replies should be sent to.

The message signal or the stored message may contain display layout information.

The message signal or the stored message may be an email message or an instant messaging message.

The present invention also provides a messaging system arranged to transmit messages the said messaging signal or to store said stored messages.

The present invention also provides a server arranged to receive or send said message signals or to store said stored messages.

The server may be arranged to convert message signals or stored messages in said format to another format and to transmit converted messages in said other format.

The server may be arranged to convert messages in another format to said format and to transmit converted messages in said format.

The server may be arranged to transmit converted messages to a client.

Advantageously the server may be arranged to retrieve messages stored on another server which were addressed to that other server, or a user account on that server, and to transmit retrieved messages to a client.

The server may be arranged to convert messages in said format to a format including display layout information. That conversion may be from XML to a format including display layout information by using Extensible Stylesheet Language (XSL), the conversion may be to Wireless Mark-up Language (WML).

The server may be arranged to store messages for a client between sessions for that client. Alternatively, the server may be arranged not to store messages for a client between sessions for that client.

The present invention also provides a client arranged to receive or send said message signals or to store said stored messages.

The client may comprise a message store and the client may be arranged to store messages between sessions with a server. Alternatively, the client may be arranged not to store messages between sessions with a server.

The messaging system, the client or the server comprising a file defining which said delimited fields the message signal of the stored message should or may contain. The messaging system, the client or the server may interpret said message signal or stored messages using said file defining the fields. Said file defining the fields maybe in XML format.

The messaging system, the client or the server may be arranged to transfer messages in said format using a HTTP protocol. The HTTP protocol may be HTTPS.

The present invention further provides a computer program product for implementing the messaging system, the client or the server.

The present invention also provides a method of transferring message signals using the said message signal, which may be done using a HTTP protocol, for example HTTPS, and provides a method of storing a message using said stored message in said format.

### BRIEF DESCRIPTION OF THE SEVERAL VIEWS OF THE DRAWINGS

The present invention will now be described, by way of example only, with reference to the accompanying drawings, of which:

FIG. 1 shows a messaging system according to the present invention;

FIG. 2 shows a push transfer of a message;

FIG. 3 shows a messaging server according to the present invention that uses other servers for routing messages;

FIG. 4 shows steps for logging on to server;

FIG. 5 shows steps for viewing a particular message;

FIG. 6 shows steps for relying to a message;

FIG. 7 shows a server according to the present invention; and

FIG. 8 shows a messaging system according to the present invention.

### DETAILED DESCRIPTION OF THE INVENTION

In the preferred embodiment of the present invention messages are sent in XML format. XML is a known format which represents information as a plain text file or “document” with tags delimiting values of the data fields. XML also provides tags defining which fields are, or may be, present in the file. In the preferred form of the invention the data definition part is kept in a separate file known as a DTD file which is referred to by the programs when interpreting the messages.

Table 1 below is a data definition for a message, in particular an email message, in XML format, and Table 2 is a message in the XML format defined by the file of Table 1.

TABLE 1
<!ELEMENT attachment (id, size, content)>
<!ATTLIST attachment name NMTQKEN #REQUIRED>
<!ATTLT5T attachment mime-type CDATA #REQUIRED>
<!ELEMENT message (id, date, to, from, return-path, reply-to, subject,
mime-version, content-type, content-transfer-encoding, size,
x-priority, x-msmail-priority, x-mailer, importance, x-mimeole,
x-rcpt-to, x-drop, x-uidl, status, attachments, inline-content,
alternative-content, attachment+)>
<!ATTLIST message id NMTOKEN #REQUIRED>
<!ATTLIST message action CDATA #REQUIRED>
<!ELEMENT id (#PCDATA)>
<!ELEMENT date (#PCDATA)>
<!ELEMENT to (#PCDATA)>
<!ELEMENT from (#PCDATA)>
<!ELEMENT return-path (#PCDATA)>
<!ELEMENT reply-to (#PCDATA)>
<!ELEMENT subject (#PCDATA)>
<!ELEMENT mime-version (#PCDATA)>
<!ELEMENT content-type (#PCDATA)>
<!ELEMENT character-set (#PCDATA)>
<!ELEMENT content-transfer-encoding (#PCDATA)>
<!ELEMENT size (#PCDATA)>
<!ELEMENT x-priority (#PCDATA)>
<!ELEMENT x-msmail-priority (#PCDATA)>
<!ELEMENT x-mailer (#PCDATA)>
<!ELEMENT importance (#PCDATA)>
<!ELEMENT x-mimeole (#PCDATA)>
<!ELEMENT x-rcpt-to (#PCDATA)>
<!ELEMENT x-drop (#PCDATA)>
<!ELEMENT x-uidl (#PCDATA)>
<!ELEMENT status (#PCDATA)>
<!ELEMENT attachments (#PCDATA)>
<!ELEMENT inline-content (#PCDATA)>
<!ELEMENT alternative-content (#PCDATA)>

In Table 1 “!ELEMENT” is a reserved XML word introducing the definition of a new data element. The fourth line of Table 1 says that there is a data element called “message” which is composite having the elements named in the list in round brackets. “!ATTLIST” is the XML reserved word that introduces the list of those elements or attributes. The part “id NMTOKEN #REQUIRED” says that for a message to be valid it must be include a value for the “message id” field; that field cannot be omitted. This is preferred to give the message a unique identifier. The remaining lines give definitions of the elements themselves detailing in particular their data type. In this case each is declared as “#PCDATA” which is a string format. The “message action” field is one for containing an instruction as to what should be done with the message. The names of the other fields are ones that would be expected for an email message, including for example: “to”—the address of the recipient, “from”—the address of the sender, and “inline-content”—the actual text of the message.

TABLE 2
<message id= 1 action=inbound>
<id> NDBBIAJMNKMNHODPAFNLCEJECKAA.andy.munarriz@
voxsurf.com </id>
<date> Mon, 16 Oct 2000 07:22:05 -0400 </date>
<to> marco@voxsurf.com </to>
<from> : “andy munarriz” andy.munarriz@voxsurf.com </from>
<return-path> andy.munarriz@voxsurf.com </return-path>
<reply-to> andy.munarriz@voxsurf.com </reply-to>
<subject> Board Minutes </subject>
<mime-version> 1.0 </mime-version>
<content-type> text/plain </content-type>
<character-set> iso-8859-1 </character-set>
<content-transfer-encoding> 7bit </content-transfer-encoding>
<status> U </status>
<attachments> 1 </attachments>
<inline-content> Hi Marco, please find attached my notes outlining our
next board meeting issues. </inline-content>
<attachment name=“BoardIssues.txt” mime-type=“text/plain”>
<id> 1 </id>
<size> 10000 </size>
<content> blah blah blah . . . </content>
</attachment>
</message>

Table 2 shows an a message containing the data defined in the file of Table 1. The value for each field is delimited by “<XXX>” and “</XXX>” where “XXX” is the name of the field. These delimiters make it straightforward to retrieve from the message the value for any particular field required.

The message in table 2 is one being passed from a server to a client (described below) and is one that has been sent to the user. The action value is set to “inbound” which indicates to the client that it should take appropriate action such as displaying to the user and storing it in the inbox of the client's message store (if indeed the client stores messages).

Attachments are not included directly in the XML files but references to them are included. An attachment attribute of a message is itself composite having attributes of size, content type, name and mime type. Attachments are preferably transferred separately from the message itself (preferably using a HTTP transfer)

Table 3 shows a message having the action value=“send”. Such a message may be passed from the client where it was composed to the server which interprets it as an instruction to route the message to its destination (again see a more detailed explanation below).

TABLE 3
<message id= XXXX action=send>
<date> Mon, 16 Oct 2000 07:22:05 -0400 </date>
<to> marco@voxsurf.com </to>
<from> : “andy munarriz” andy.munarriz@voxsurf.com </from>
<return-path> andy.munarriz@voxsurf.com </return-path>
<reply-to> andy.munarriz@voxsurf.com </reply-to>
<subject> Board Minutes </subject>
<mime-version> 1.0 </mime-version>
<content-type> text/plain </content-type>
<character-set> iso-8859-1 </character-set>
<content-transfer-encoding> 7bit </content-transfer-encoding>
<importance> Normal </importance>
<attachments> 1 </attachments>
<inline-content> Hi Marco, please find attached my notes outlining our
next board meeting issues. </inline-content>
<attachment name=“BoardIssues.txt” mime-type=“text/plain”>
<id> 1 </id>
<size> 10000 </size>
<content> blah blah blah . . . </content>
</attachment>
</message>

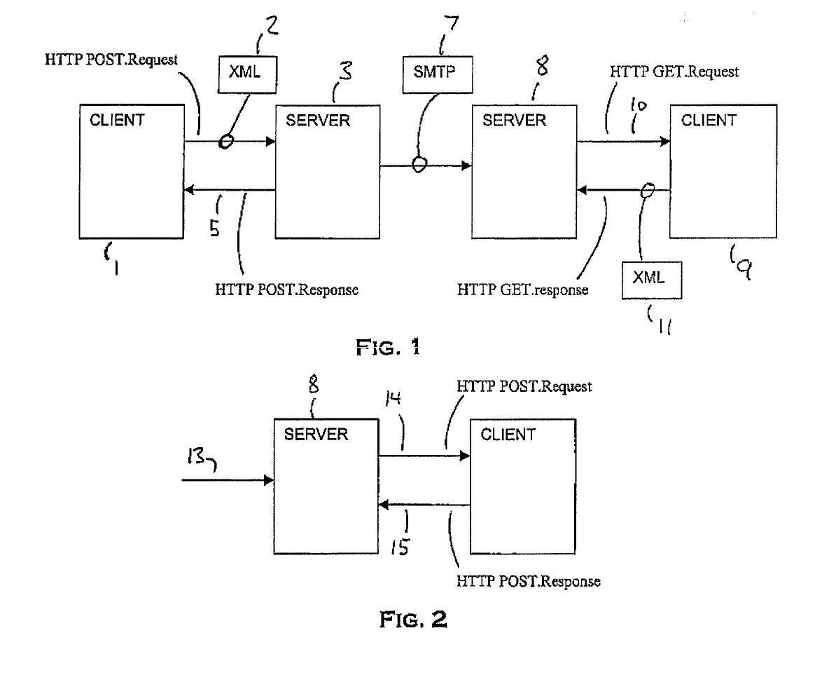

FIG. 1 shows an email system according to the present invention which transfers messages between the a client program and a server in the XML format described above. The basic operation of the system is as follows. A message is prepared using a program on a client 1, which compiles the message into a file or document 2 in the XML format of Table 2, making reference to a file containing the definition given in Table 1. This message file 2 is transferred to the server 3, in particular to a messaging server program there.

The preferred method of transferring the XML file between client and server is to use the HTTP protocol. (The secure version HTTPS may be used.) This is a simple communication; the client uses the POST.request method 4 of the HTTP protocol which the server accepts, thus receiving the XML file; the server then acknowledges with the POST.reply method 5 of the HTTP protocol. The HTTP protocol is commonly used to transfer files in the provision of pages of the world wide web but it is also suitable for use in the present invention. A different transfer protocol from HTTP could be used, however, for transferring the XML message file. HTTP is also attractive for use in the present invention because most firewalls are configured to allow it through.

The messaging server program on the server 3 receives the message file and on recognising that it contains a message it attempts to route it to its destination. On inspecting the “to” field the server discovers, for example, that the message is not destined for a recipient whose home server is itself 3, it converts the message to the format in which it may be transferred by the SMTP protocol. The message is then transferred 7 by SMTP to the home server 8 of the intended recipient. The server 3 combines in a single server communicating with the client and routing the message to its destination (by SMTP). In another example of the invention to be described later those functions are performed by separate servers.

On receipt of the message the server 8 converts it to the XML format of Table 2 and stores it on the server 8 in the mailbox of the intended recipient. There it remains until the server 8 receives a request from the client program 9 of the recipient to receive (or view) the message. To transfer the message to the client program the client 9 issues a HTTP GET.request and the server 8 then supplies the message to the client 9 in the XML format 11 using the GET.response method 12.

The system may be configured so that the client program stores the messages at its computer, the server deleting the message from its mailbox for the user once the message has been transferred to the client. This is useful where the client is set to retrieve messages from many servers where it compiles a consolidated set of messages from these sources. Alternatively the server can be configured to keep the messages indefinitely in the user's mailbox with the client being used just to view them when required. This is useful when a user needs to view his or her messages from different computers. A further configuration is for both client and server to store the messages, with them synchronising their stores from time to time. All these possibilities are achieved using the same transfer mechanism for the messages.

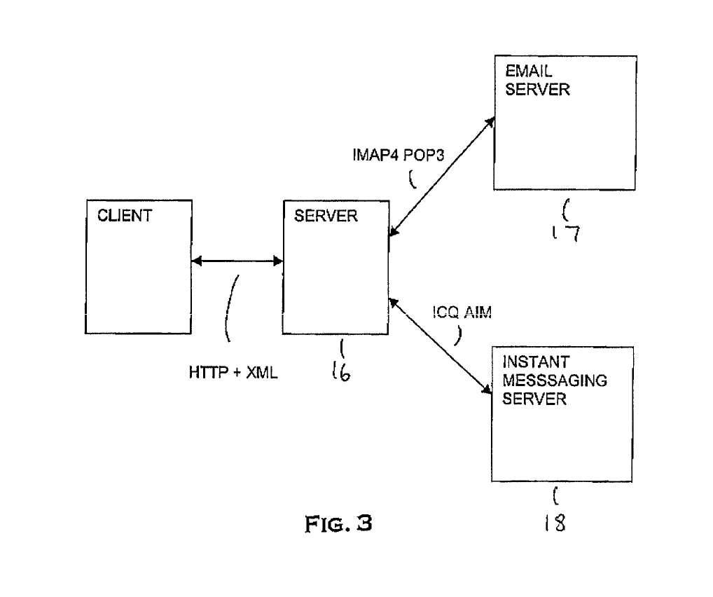

FIG. 2 shows a message transfer initiated by the server in what is called a “push” arrangement. Here the server 8 receives a message 13. Having converted it if necessary to XML, the server sends the message to the client 9 using the POST.request method 14 of the HTTP protocol. The client 9 acknowledges receipt of the message using the POST.response method 15. To avoid wasting resources the server only pushes messages when it has a reasonable expectation that the client is active. This is established through a log on procedure and periodic communications between the client and server to confirm that the client is still active. This push method of transferring messages is used to support instant messaging and chat applications, for example those provided by ICQ. Another use is to provide an indication that new mail has arrived.

One prior art approach to email is exemplified by mobile phones. As noted above, mobile phones support messaging by displaying WML files received from the server. This means that the phone acts as a “dumb terminal” or “thin client” merely showing the displays intended by the server. This has a certain flexibility in that the displays, and hence the functionality, can be changed at the server without the need for reprogramming the phone. On the other hand the phone provides no processing capability and so can offer little in the way of message storage, offline editing etc. In contrast, in the present invention the XML message format contains named fields which the client presents as it desires. (In the preferred embodiment of the invention the XML message file contains no layout information).

Another common prior art approach is to have an email client program which offers many facilities by itself without interacting with the server, such as offline editing of messages, contact management, message filtering. A problem with these programs is that they are large and difficult to develop owing to the many different messaging protocols that they have to support to be useful.

The present invention improves upon both of these approaches. In the present invention, because display layout is (in general) left to the client, intelligent clients can be developed. Further, the simplicity of the XML format for the messages makes them easy to convert to other formats making program development easy and also making the format one likely to be used widely, which in turn makes message conversion at the server the more usual arrangement with the result that client programs need only to support the XML message format simplifying client development further. Client programs therefore become smaller and easy to write making their development for specialised purposes more economic.

The present invention does not, however, leave situations where thin clients that merely present displays determined by the server are required. XML is very easily tuned into a display format, like WML, HTML or VoiceML, by the use of Extensible StylesheetLanguage (XSL) as will be appreciated by the skilled person. Thus a server based on the XML message format of the present invention may easily provide WML files for mobile phones.

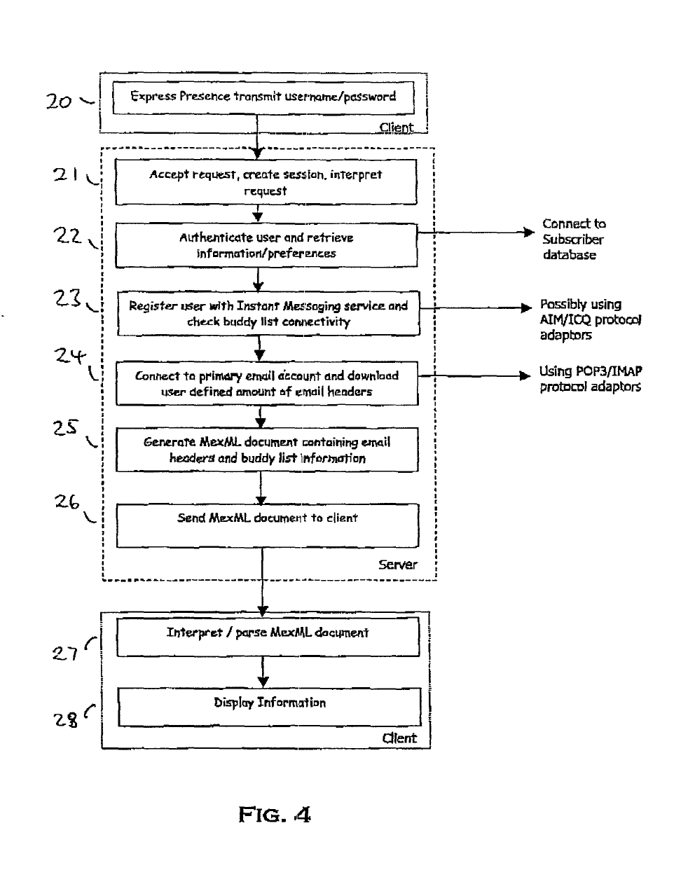

FIG. 3 shows a alternative embodiment of the invention in which the server 16 that communicates with the client 1 is not directly responsible for routing the client's messages but which uses other servers such as conventional email server 17 and instant messaging server 18 to do that. This embodiment has the advantages over that of FIGS. 1 and 2 that it does not require conventional servers, such as email 17 and instant messaging server 18 to be rewritten, and it allows such services to be consolidated on behalf of the client.

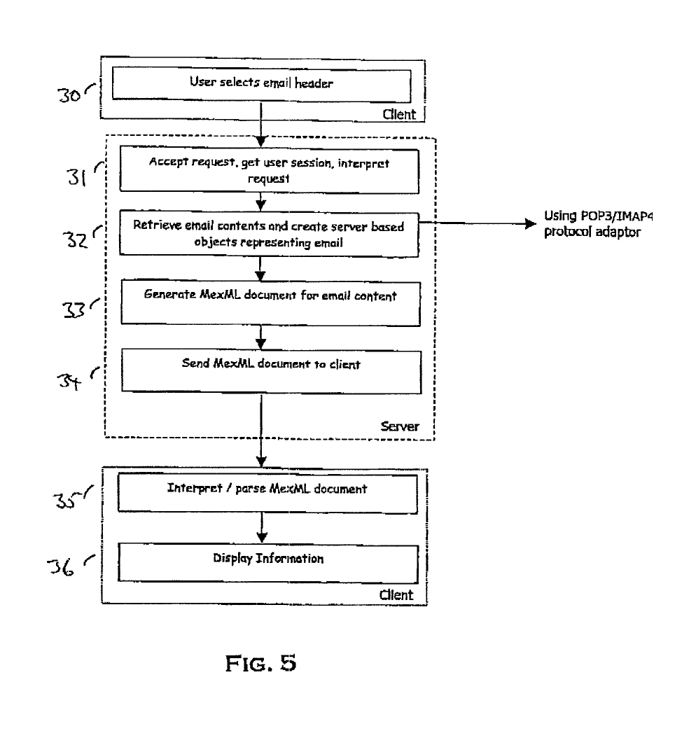

FIGS. 4, 5 and 6 are flow diagrams showing more details of the processing of messages in the client 1 and the server 16. Some aspects of this embodiment are different, for the purpose of illustration, to that of FIGS. 1 and 2 above, but of course generally similar changes can be made to the embodiment of FIGS. 1 and 2 and vice versa.

FIG. 4 shows steps taken at log on of a user that makes use of email and instant messaging. In the first step 20 a client program transmits the user name and password entered by the user. These are passed as parameters of an HTTP POST.request to the server. Processing then continues on the server. At step 21 the server accepts the log on request, creates a processing session for the client, and interprets the request recognising it as a log on request and therefore initiating the rest of the procedure in FIG. 4. At step 22 the server then authenticates the user and against a database of subscribers containing their account details and retrieves from that database the user's preferences and settings. Next at step 23 the server announces the user's presence to an instant messaging service (18 FIG. 3), such as ICQ or AIM, and retrieves the user's “buddy list”. A buddy list is a set of other users with whom a user would want to engage in instant messaging or “chat”, and the list retrieved indicates whether those people are logged on and are available for such interaction. Next, or alternatively before or concurrently with the step 23, at step 24 the server retrieves a list of message headers in an email account on another server, for example using the POP3 or IMAP4 protocol, or using the XML and HTTP protocols of the present invention if supported there. The account is the one the user has specified as the primary account; others may be inspected at the user's option later. The buddy list and email header list are compiled into an XML file or “document”, at step 25, and that is then transmitted at step 26 to the client. At the client the XML document is then interpreted (step 27) and is then displayed (step 28).

Note that in this example in contrast to that of FIGS. 1 and 2 the server 16 that communicates with the client is not an addressed destination for email messages rather it retrieves them from other “destination” servers like a traditional email client would using POP3 or IMAP4 and so acts as an intermediary for its clients.

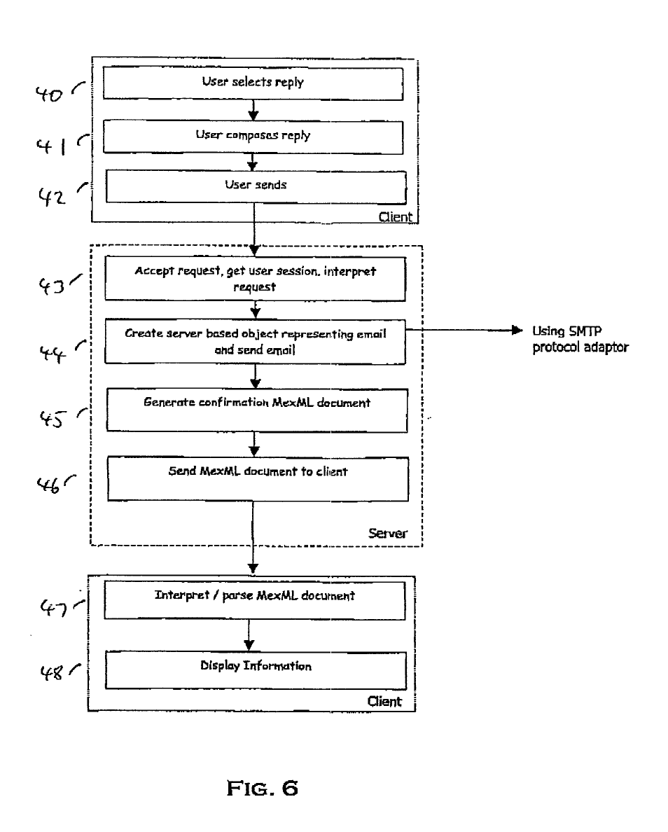

FIG. 5 shows steps taken to retrieve a message once a list of headers has been displayed on the client. As described above there are several possibilities for where messages are stored. If the client stores copies of messages, the list of message headers displayed to the user incorporates both those of the messages stored locally and the new ones downloaded from the server. At step 30 the user selects a message that is not available at the client. The client program in response requests that message from the server. The server then accepts the request (step 31), assigns it to the user's session and interprets it initiating the rest of the procedure in FIG. 4. At step 32 the server retrieves the requested message from the appropriate email account on another, possibly remote, server using IMAP4 or POP3. (Alternatively if the server already has a copy of the message it retrieves it from its store.) Then at step 33 the server turns the message, if necessary, into an XML document. This conversion takes places via an object representation in the program of the server and from there into XML. Finally the server (step 34) transmits the XML document to the client. At the client the client application parses the XML document (step 35) and displays the message in a manner determined by the client (step 36).

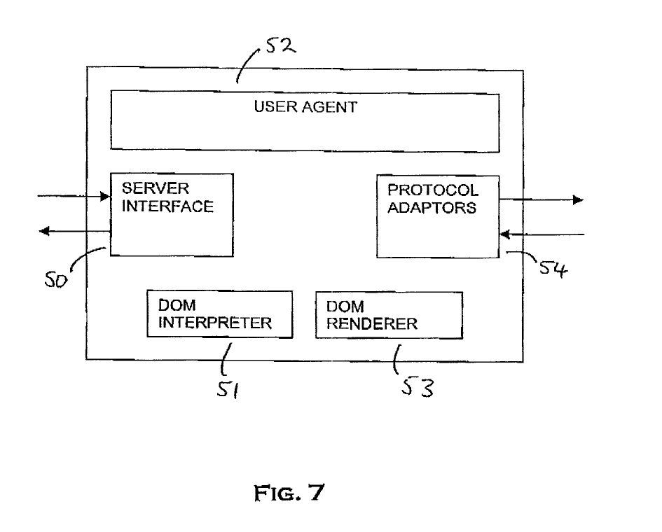

FIG. 6 shows steps performed for replying to the message. At step 40 the user selects to reply to a received message and the client displays a new message form, with a copy of the received message in the body and preaddressed to the sender of the received message. The user then composes the reply (step 41) and selects to send the new message (step 42). The client then sends the new message to the server in XML format using a HTTP POST.request (again step 42). The request is accepted at the server (step 43), is assigned to the relevant user session and is interpreted as a request to send a message thereby initiating the rest of the procedure of FIG. 6. Next at step 44 the server creates a program object representing the message (since this is the form in which it is most easily manipulated by a program), and sends it to the server 17 (FIG. 3) using SMTP. The server then generates (step 45) a confirmation for the client, again in XML, and sends it to the client (step 46) using the HTTP response to the HTTP request made by the client at step 42. The client parses that XML response and learns that the message has been sent (step 47) and displays that information (step 48) by displaying the message's header in the list of sent messages and making an appropriate indication in the display of the message itself.

Preferably the XML documents contain fields instructing the server (or the client) what is to be done. In the case of an XML document containing message, one or more fields may contain an instruction that the message should be sent, stored as a draft or deleted etc., the fields of the message itself shown in Table 2 being completed as necessary. While such instructions could be encoded in the transfer protocol, for example in a field of the HTTP request, this is not preferred since the client and server programs would have to be recoded if a transfer protocol different from HTTP were to be used. An alternative is to have the instruction to the server implicit; for example, if the message has a completed to field it will attempt to route it to its destination.

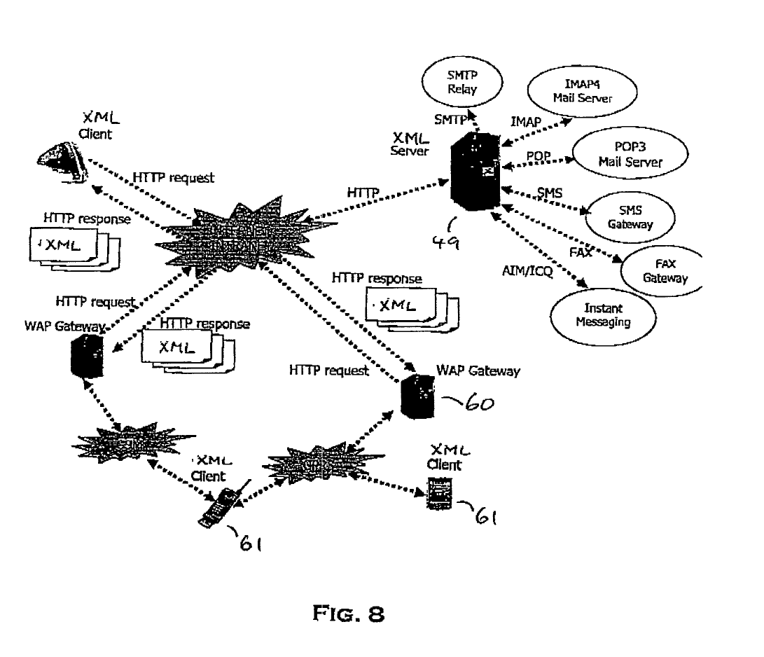

FIG. 7 shows the architecture of a server program 49 according to the present invention in particular that of server 16 in FIG. 3. The main components are a server interface 50, a DOM interpreter 51 (“DOM” stands for “Document Object Model”), a user agent 52, a DOM renderer 53 and protocol adapters 54. The server interface 50 accepts client requests and interprets them, and sends responses (and push requests) to the client. It also attends to management of the client sessions. The DOM interpreter 51 parses the XML documents, producing corresponding program objects from them, enabling the server interface to interpret how to process them. The user agent 52 carries out various processing tasks including authenticating the user (or the client if for example the client is some automatic process) with the subscriber database. (Note that the subscriber database is not necessarily at the server and may be shared by more than one server.) The user agent also processes messages, forwarding them to the client or other servers as appropriate, managing message lists, managing contacts, filtering messages. It carries out these tasks in ways specified by the users settings or preferences. The DOM renderer 53 generates XML documents representing messages, confirmations, etc., for transmission to the client or other servers. This it does from an object representation used in the user agent. It also converts the XML documents to formats containing layout information e.g. WML which is done using XSL as noted above. The protocol adapters are provided to interoperate with servers using protocols such as POP3, IMAP4, SMTP, ICQ, AIM, SMS and proprietary protocols, the format of the messages being converted as appropriate for these protocols to and from XML via the object representation of the program.

FIG. 7 does not show a long term message store, i.e. one in which the user can keep messages between sessions. As noted above it is possible to have that facility at the server nonetheless. Equally it is not essential; if messages are to be stored long term this can be done at the client or as in the example of FIG. 3 given above in some other server (email server 17), the server of the invention acting as an intermediary. Such an intermediary or “middleware” will be of use to service provider wanting to offer a messaging solution that integrates many different messaging services.

The tasks of the client have been noted above and include communicating with the server, interpreting and parsing XML documents form the server, expressing presence (online, offline, unavailable etc.) to the server. Another task may be to indicate that it is the primary client for a user in the case that a user may have more than one client connected. The server sends instant messages and new mail notifications to that client. The primary client is set by the user manually or is inferred by the system from user activity at the clients.

FIG. 8 shows a larger messaging system. A server 49 according to the present invention acts as an intermediary or gateway for many messaging protocols. A WAP gateway 60 serves a WAP client 61 (a mobile phone) and serves to covert HTTP requests to WAP requests. Preferably the server 49 supplied the WAP client with WML files, the server 49 providing the conversion from XML. Alternatively the server 49 provides XML files and the WAP gateway converts them to WML for the client 61.

While only basic email facilities have been described it will be apparent to the person skilled in the art that the present invention may be used to support many other facilities. It will also be apparent that the invention is not limited to email but may be applied to other messaging applications, for example, SMS and instant messaging, FAX and telex. Further although client/server arrangements have been described the invention may, of course, be used for messaging where there is no particular client or server.

What is claimed is:

1. A message signal, containing a message, or a machine readable stored message, wherein the message comprises:
a format having delimiters that both mark regions containing values of fields; and
identify which fields those are.

2. A message signal or a stored message as claimed in claim 1 wherein the said format is XML.

3. A message signal or a stored message as claimed in claim 1 comprising a field, in said format, indicating a recipient of the message.

4. A message signal or a stored message as claimed in claim 1 comprising a field, in said format, indicating a sender of the message.

5. A message signal or a stored message as claimed in claim 1 comprising a field, in said format, indicating an address replies should be sent to.

6. A message signal or a stored message as claimed in claim 1 containing display layout information.

7. A message signal or a stored message as claimed in claim 1 wherein said message is an email message.

8. A message signal or a stored message as claimed in claim 7 wherein the said format is XML.

9. A message signal or a stored message as claimed in claim 1 wherein said message is an instant messaging message.

10. A message signal or a stored message as claimed in claim 9 wherein the said format is XML.

11. A message signal or a stored message as claimed in claim 1 comprising a field, in said format, indicating an action to be carried out on the message.

12. A message signal or a stored message as claimed in claim 11 wherein the said format is XML.

13. A message signal or a stored message as claimed in claim 11 wherein the field indicating the action to be carried out on the message indicates that it is to be sent.

14. A message signal or a stored message as claimed in claim 11 wherein the field indicating the action to be carried out on the message indicates that it is to be stored.

15. A message signal or a stored message as claimed in claim 11 wherein the field indicating the action to be carried out on the message indicates that it is to be deleted.

16. A messaging system arranged to transmit messages using a message signal, containing a message, or to store a machine readable message, wherein the message comprises:
a format having delimiters that both mark regions containing values of fields; and
identify which fields those are.

17. A messaging system as claimed in claim 16 wherein the said format is XML.

18. A messaging system as claimed in claim 16 wherein said message is an email message.

19. A messaging system as claimed in claim 16 wherein said message is an instant messaging message.

20. A messaging system as claimed in claim 16 comprising a field, in said format, indicating an action to be carried out on the message.

21. A messaging system as claimed in claim 20 wherein the field indicating the action to be carried out on the message indicates that it is to b e sent.

22. A messaging system as claimed in claim 20 wherein the field indicating the action to be carried out on the message indicates that it is to be stored.

23. A messaging system as claimed in claim 20 wherein the field indicating the action to be carried out on the message indicates that it is to be deleted.

24. A messaging system as claimed in claim 16, arranged to transfer messages in said format using a HTTP protocol.

25. A messaging system as claimed in claim 24 wherein the HTTP protocol is HTTPS.

26. A messaging system as claimed in claim 24 wherein the messages transferred using HTTP are in XML format.

27. A server arranged to receive or send one message signals, containing a message, or to store a machine readable message, wherein the message comprises:
a format having delimiters that both mark regions containing values of fields; and
identify which fields those are.

28. A server as claimed in claim 27 wherein the said format is XML.

29. A server as claimed in claim 27 arranged to convert message signals or stored messages in said format to another format and to transmit converted messages in said other format.

30. A server as claimed in claim 27 arranged to convert messages in another format to said format and to transmit converted messages in said format.

31. A server as claimed in claim 30 arranged to transmit said converted messages to a client.

32. A server as claimed in claim 27 arranged to retrieve messages stored on another server which were addressed to that other server, or a user account on that server, and to transmit retrieved messages to a client.

33. A server as claimed in claim 27 arranged to convert messages in said format to a format including display layout in formation.

34. A server as claimed in claim 33 wherein said format is XML and the server is arranged to perform said conversion to a format including display layout information using Extensible Stylesheet Language (XSL).

35. A server as claimed in claim 33 wherein said conversion is to Wireless Mark-up Language (WML).

36. A server as claimed claim 27 comprising a message store wherein the server is arranged to store messages for a client between sessions for that client.

37. A server as claimed claim 27 wherein the server is arranged not to store messages for a client between sessions for that client.

38. A server as claimed in claim 27, arranged to transfer messages in said format using a HTTP protocol.

39. A server as claimed in claim 38 wherein the HTTP protocol is HTTPS.

40. A server as claimed in claim 38 wherein the messages transferred using HTTP are in XML format.

41. A server as claimed in claim 27 arranged to carry out an action on a message, that action being indicated in a field of the message, in said format.

42. A server as claimed in claim 41 wherein the field indicating the action to be carried out on the message indicates that it is to be sent and the server is responsive to that field to send the message.

43. A server as claimed in claim 41 wherein the field indicating the action to be carried out on the message indicates that it is to be stored and the server is responsive to that field to store the message.

44. A server as claimed in claim 41 wherein the field indicating the action to be carried out on the message indicates that it is to be deleted and the server is responsive to that field to delete the message.

45. A server as claimed in claim 27 comprising a file defining which said delimited fields the message signal of the stored message should or may contain.

46. A server as claimed in claim 45 that interprets said message signal or stored messages using said file defining the fields.

47. A server as claimed in claim 45 wherein said file defining the fields is in XML format

48. A client arranged to receive or send message signals, containing a message, or to store a machine readable message, wherein the message comprises:
a format having delimiters that both mark regions containing values of fields; and
identify which fields those are.

49. A client as claimed in claim 48 wherein the said format is XML.

50. A client as claimed in claim 48 comprising a message store, wherein the client is arranged to store messages between sessions with a server.

51. A client as claimed in claim 48 wherein the client is arranged not to store messages between sessions with a server.

52. A client as claimed in claim 48 comprising a file defining which said delimited fields the message signal of the stored message should or may contain.

53. A client as claimed in claim 52 that interprets said message signal or stored messages using said file defining the fields.

54. A client as claimed in claim 52 wherein said file defining the fields is in XML format.

55. A client as claimed 48, arranged to transfer messages in said format using an HTTP protocol.

56. A client as claimed in claim 55 wherein the HTTP protocol is HTTPS.

57. A client as claimed in claim 55 wherein the message transferred using HTTP is in XML format.

58. A client as claimed in claim 48 arranged to carry out an action on a message, that action being indicated in a field of the message, in said format.

59. A client as claimed in claim 58 wherein the field indicating the action to be carried out on the message indicates that it is to be sent and the server is responsive to that field to send the message.

60. A client as claimed in claim 58 wherein the field indicating the action to be carried out on the message indicates that it is to be stored and the server is responsive to that field to store the message.

61. A client as claimed in claim 58 wherein the field indicating the action to be carried out on the message indicates that it is to be deleted and the server is responsive to that field to delete the message.

62. A computer program product for implementing a messaging system, a client, or a server, arranged to receive or send message signals, containing a message, or to store a machine readable message, wherein the message comprises:
a format having delimiters that both mark regions containing values of fields; and
identify which fields those are.

63. A method of transferring message signals wherein the message signals comprises:
a format having delimiters that both mark regions containing values of fields; and
identify which fields those are.

64. A method of transferring message signals as claimed in claim 63 that uses a HTTP protocol to transfer the message signal.

65. A method of transferring message signals as claimed in claim 64 wherein the HTTP protocol is HTTPS.

66. A method of transferring message signals as claimed in claim 63 wherein the signals are in XML format.

67. A method of storing a message wherein the stored message comprises:
a format having delimiters that both mark regions containing values of fields; and
identify which fields those are.

68. A method of storing messages as claimed in claim 67 wherein the stored messages are in XML format.
